(19) United States
(12) Patent Application Publication
(10) Pub. No.: US 2009/0327760 A1
(43) Pub. Date: Dec. 31, 2009

(54) Tachograph

(75) Inventors: Andreas Lindinger, Flozlingen (DE); Gunnar Schmidt, Villingen-Schwenningen (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automotive GmbH, Hannover (DE)

(21) Appl. No.: 12/524,282

(22) PCT Filed: Jan. 15, 2008
(86) PCT No.: PCT/EP2008/050396

§ 371 Date: Jul. 23, 2009

(30) Foreign Application Priority Data
Jan. 25, 2007 (DE) 10 2007 004 645.8

(51) Int. Cl. G06F 12/14; G06F 21/00; G01P 1/12; G06F 13/00

(52) U.S. Cl. 713/193; 726/21; 346/33 D; 710/301; 713/189

(57) ABSTRACT

A tachograph includes at least one chip card reading unit and, at least one chip card with secure memory. Secured data transmission can be fed to the at least one chip card reading unit. On the at least one chip card, at least one user-defined piece of identification information is securely stored which is independent of a specified piece of identification information for a specified operation of the tachograph. The tachograph is constructed so as to authenticate the at least one chip card in accordance with the at least one piece of user-defined identification information, and to read data securely from the at least one chip card and/or to store data securely on the at least one chip card.

### PRIORITY CLAIM

This is a U.S. national stage of application No. PCT/EP2008/050396, filed on 15 Jan. 2008, which claims Priority to the German Application No.: 10 2007 004 645.8, filed: 25 Jan. 2007 the contents of both being incorporated herein by reference.

### BACKGROUND OF THE INVENTION

1. Field of the Invention

The invention relates to a tachograph and particularly to a digital tachograph.

2. Prior Art

A digital tachograph can be installed in a vehicle, particularly in a heavy goods vehicle, to store a speed of travel for the vehicle and a traveling time for the vehicle for the later evaluation of the data. The tachograph is security certified and forms a secure environment for processing and storing the data. In addition, such a tachograph involves the use of security certified cryptographic algorithms to securely store the data in a form protected against manipulation.

FR 2 612 319 A1 discloses a method and an apparatus for controlling use of a vehicle or a plurality of vehicles. Various parameters are captured for the purpose of later use which are representative of use of the vehicle. The capture requires use of a confidential identification code. The identification code also controls the operation of the vehicle. The apparatus has a read/write device for reading or writing to a chip card and a keypad for inputting the identification code used to authorize use of the chip card.

DE 102 10 320 A1 discloses a method of dual recording journey time control in heavy goods vehicles. A chip card read/writer an have a driver chip card and an HGV chip card inserted into it. Each driver is provided with an explicit driver identification as proof of authorization in the form of the drive chip card issued by the relevant authorities. In addition, each HGV is accordingly provided with an HGV identification as proof of authorization in the form of the HGV chip card, which is likewise issued by the authorities. To drive, both chip cards need to be in the chip card read/writer. The identifications which are stored on the respective chip card are transmitted to the chip card read/writer in encrypted form.

U.S. Pat. No. 6,141,609 discloses an appliance for recording information while a vehicle is traveling. To associate the recorded data with the driver of the vehicle, the appliance is informed about an identity of the driver by a chip card reader, which holds a chip card for the driver, prior to the start of the journey. To prevent misuse, the driver also needs to prove his identity by using a keypad to input a PIN code.

WO 97/13208 A1 discloses an electronic driver's log book. The electronic driver's log book has a removable module with a nonvolatile memory inserted into it for the purpose of storing protected data packets. A driver is provided with access through voice input or input of a password or biometric feature following the insertion of the memory. Driver-specific data is used to decrypt a secret or private key from a key pair for public key encryption. The data to be recorded is stored as protected data packets with digital signatures, which are formed by encrypting a digital hash value with the secret key.

DE 10 2004 043 052 B3 discloses a method for recognizing manipulation on an arrangement with a tachograph and a sensor, The tachograph comprises a transfer module for transforming a request command into a form in line with a data transmission protocol and for encrypting the protocol-compliant data signals and for transferring said signals to a data signal interface. The request command is routed to the sensor via the data signal interface by means of a data line. A corresponding inverse path with essentially inverse processes is taken by a data signal from the sensor to a data signal evaluation module in the tachograph.

US 2003/0194088 A1 discloses a method for transmitting data between components of a system electronics unit in a mobile system. The components comprise an encryption appliance or a decryption appliance and communicate via said appliances by means of realtime encryption and decryption of the data.

### SUMMARY OF THE INVENTION

An object of the invention is to provide a tachograph which can be used easily and versatilely.

In line with a first embodiment of the invention, a tachograph comprises at least one chip card reading unit. The at least one chip card reading unit is supplied with at least one chip card having a secure memory and secure data transmission. The at least one chip card securely stores at least one user-defined identification information item which is independent of an identification information item prescribed for operation of the tachograph. The tachograph is designed to authenticate the at least one chip card based on the at least one user-defined identification information item and to read data in secure form from the at least one chip card and/or to store data in secure form on the at least one chip card.

The tachograph is a very secure design for its prescribed operation and that this security of the tachograph is not only useful for the prescribed operation of the tachograph but is also advantageous for other applications. The prescribed operation of the tachograph is prescribed by an institution, particularly a national institution, and/or is prescribed by legal regulation or decree. The prescribed operation of the tachograph comprises the secure storage of travel data for later evaluation, particularly a speed of travel and a traveling time. The secure storage is effected such that the stored data is protected against unauthorized manipulation and that it is possible to reliably identify manipulation of the data. By way of example, the secure storage comprises ascertainment of a digital signature for the data and preferably digital encryption of the data. The secure memory comprises a secure key memory and/or a secure data memory, for example. The data may also comprise the user-defined identification information item or components thereof.

The identification information item prescribed for the prescribed operation of the tachograph is prescribed by the institution, particularly the national institution and is stored on what is referred to as a tachograph card or workshop card, use of the tachograph card and the workshop card is limited to the prescribed operation of the tachograph or prescribed setup and maintenance work on the tachograph in a workshop. By providing the user-defined identification information item stored on the at least one chip card, the secure hardware and software of the tachograph can be used for user-defined applications independently of the identification information item prescribed for the prescribed operation of the tachograph. A user-defined application includes the secure storage of additional data by the tachograph, not required for the prescribed operation of the tachograph. One advantage is that the user-defined applications which use the secure and preferably security certified hardware and software of the tachograph do not require provision of any separate components or units which allow authentication to be performed and/or data to be read in secure form and/or data to be stored in secure form. This allows costs to be saved.

The user-defined identification information item comprises at least one cryptographic key, particularly a private key for digital signing or for use with an asymmetric encryption and decryption algorithm or a key for use with a symmetric encryption and decryption algorithm, and/or at least one digital certificate and/or at least one user identifier, a customer identifier or workshop identifier, and/or at least one user group identifier. The user-defined identification information item allows secure identification of a user, for example a driver, a customer, a company or a workshop. The data that is read in secure form from the at least one chip card and/or are stored in secure form on the at least one chip card may also comprise the user-defined identification information item or components thereof, e.g. the user identifier or public key for asymmetric encryption. One advantage is that the user-defined identification information item can be defined, by the company which uses the tachograph in one of its vehicles, or by a vehicle manufacturer which equips the vehicle with the tachograph, independently of the identification information item prescribed for the prescribed operation of the tachograph and in a manner suitable for the respective provided application, for example by means of a dedicated digital certificate, dedicated cryptographic keys, dedicated user identifiers and so on.

The user-defined identification information item is used to use the at least one chip card, for secure reading and transmission of configuration data from the tachograph to a further tachograph, without the workshop card in order to do so. This simplifies the configuration of the tachograph, and it is very simple to configure a plurality of tachographs using the same configuration data. This relates particularly to customer-specific or company-specific configuration of the tachographs. The susceptibility of the configuration to error is thereby reduced. In addition, it is possible to register and store the presence of the at least one chip card in the chip card reading unit. This makes it possible to establish, upon later evaluation of the data, when the at least one chip card, respectively identified by its user-defined identification information item, has been in the chip card reading unit. This allows customer-specific data capture and evaluation, for example when a journey was made and for which customer.

In one embodiment, the tachograph involves the at least one user-defined identification information item encoding at least one access right for access to at least one functional unit and/or at least one use right for use of the at least one functional unit. The tachograph is designed to take the at least one user-defined identification information item as a basis for permitting or preventing access to at least one functional unit and/or use of the at least one functional unit. The at least one functional unit may be enclosed by the tachograph or may be arranged externally with respect thereto in the vehicle. By way of example, the at least one functional unit comprises a secure memory in the tachograph, a data capture unit for securely capturing and storing user-defined data in the tachograph, an engine immobilizer in the vehicle, a communication unit in the vehicle for, by way of example, transmission of data stored in the tachograph to a vehicle-external computation unit, for example via a radio link. The advantage is that the at least one functional unit can be accessed only by authorized users or user groups. The at least one functional unit can be used by authorized users or user groups only when the functional unit has been enabled by the chip card using an appropriate user-defined identification information item, for example. The security functionality of the at least one chip card and of the tachograph for authentication, storage and transmission of data allows misuse by unauthorized parties to be prevented.

In this context, it is advantageous if the tachograph involves the access right or the use right comprising a time limitation. The tachograph is designed to take the time limitation as a basis for limiting an access period for access to the at least one functional unit or a use period for use of the at least one functional unit and/or for permitting or preventing the access to the at least one functional unit or the use of the at least one functional unit only within a period prescribed by the time limitation. This has the advantage that the at least one functional unit can be enabled or disabled for access or use with a time limit, for example on the basis of the payment of a fee. This means that additional functionality can be provided at a charge very easily and securely, that is to say in a form protected against manipulation.

In a further embodiment, the tachograph comprises at least one data interface for sending and/or receiving data to and from at least one functional unit in the vehicle. In addition, the tachograph is designed to provide the at least one user-defined identification information item or a component thereof for the at least one functional unit of the vehicle via the at least one data interface. The component of the user-defined identification information item is the user identifier, the user group identifier and/or the public key. By way of example, said identification information item is provided by sending it to the at least one functional unit, based on a prescribed event, for example the insertion of the at least one chip card into the at least one chip card reading unit, or upon request by the at least one functional unit.

The advantage is that the at least one functional unit of the vehicle provides its respective functionality in the vehicle based on the user-defined identification information item, which is made available to the tachograph by the at least one chip card. In addition, the user-defined identification information item can be used, by way of example, for secure data transmission to or from the tachograph, to or from other functional units in the vehicle and/or to or from other units outside the vehicle, for example a personal computer. In addition, provision may be made for the presence of the at least one chip card in the tachograph to be rendered checkable by the at least one functional unit of the vehicle. In one embodiment, said functional unit can then provide its functionality for use only if the at least one chip card is present, for example. Such a functional unit in the vehicle is an engine immobilizer.

In this connection, it is advantageous if the tachograph is designed to provide the at least one user-defined identification information item or the component thereof for the at least one functional unit of the vehicle such that it can be verified by said unit cryptographically. The cryptographically verifiable provision comprises digital signing of the at least one user-defined identification information item or of the component thereof using the private key, for example. Preferably, the digital signature comprises a time stamp and/or a sequence number. The digital signature is provided together with the at least one user-defined identification information item or the component thereof. The at least one user-defined identification information item or the component thereof can be checked, that is to say verified, easily and reliably by the at least one functional unit of the vehicle using the digital signature and the public key. This reliably protects the provision of the at least one user-defined identification information item or of the component thereof against manipulation.

In a further embodiment, the tachograph comprises at least one data interface for sending and/or receiving data to and from the at least one functional unit of the vehicle. In addition, the tachograph comprises at least one cryptographic functional unit provided for the prescribed operation of the tachograph. The tachograph is designed to use the at least one cryptographic functional unit to cryptographically process and/or securely store and/or securely provide data, which can be supplied to the tachograph by the at least one functional unit of the vehicle via the at least one data interface, for the at least one functional unit of the vehicle on the basis of the at least one user-defined identification information item.

By way of example, the cryptographic processing comprises the digital signing and/or encryption and/or decryption and/or authentication and/or negotiation of a cryptographic key, particularly for use with a symmetric encryption and decryption algorithm, and/or secure storage and/or checking of the integrity of data or associated data structures and/or checking of the completeness of data and/or recognition of what are known as replay attacks and/or recognition of alterations in the data. The cryptographic functional unit is designed for the cryptographic processing of data. One advantage is that the secure hardware and software of the tachograph and particularly the cryptographic functional unit thereof, which meets high security demands, can be used not only by the tachograph itself but also by the at least one functional unit of the vehicle. This allows said functional unit to be secure and reliable. In addition, it may be particularly inexpensive, since it does not require a dedicated cryptographic functional unit. The negotiation of the cryptographic key comprises the negotiation of a session key with limited time validity. The negotiation is preferably effected by using a private and a public key. The encryption and/or decryption of data can also be effected on the basis of such a session key. In addition, such a session key can also be used in order to ascertain a message authentication code.

In line with one embodiment of the invention is distinguished by a tachograph which comprises at least one data interface for sending and receiving data to and from at least one functional unit in a vehicle. The tachograph comprises at least one cryptographic functional unit provided for prescribed operation of the tachograph. The tachograph is designed to use the at least one cryptographic functional unit to cryptographically process and/or securely store and/or securely provide data, which can be supplied to the tachograph by the at least one functional unit of the vehicle via the at least one data interface, for the at least one functional unit of the vehicle.

By way of example, the cryptographic processing comprises the digital signing and/or encryption and/or decryption and/or authentication and/or negotiation of a cryptographic key, particularly for use with a symmetric encryption and decryption algorithm, and/or secure storage and/or checking of the integrity of data or associated data structures and/or checking of the completeness of data and/or recognition of what are known as replay attacks and/or recognition of alterations in the data. The negotiation of the cryptographic key comprises particularly the negotiation of a session key with limited time validity. The negotiation is preferably effected by using a private and a public key. The encryption and/or decryption of data can also be effected on the basis of such a session key. In addition, such a session key can also be used to ascertain a message authentication code. The cryptographic functional unit is designed for cryptographically processing data.

One embodiment of the invention is based on the insight that the tachograph is of very secure design for its prescribed operation and that this security of the tachograph is not only useful for the prescribed operation of the tachograph but also advantageous for other applications and particularly the at least one functional unit of the vehicle. The prescribed operation of the tachograph is prescribed by an institution, particularly a national institution and/or is prescribed by a legal regulation or decree. The prescribed operation of the tachograph comprises particularly the secure storage of travel data for later evaluation, particularly a speed of travel and a traveling time. The secure storage is effected such that the stored data are protected against unauthorized manipulation and that manipulation of the data can be recognized reliably. By way of example, the secure storage comprises ascertainment of a digital signature for the data and possibly digital encryption of the data. The secure memory comprises a secure key memory and/or a secure data memory, for example. The signing and the encryption and decryption are effected by means of the cryptographic functional unit.

One advantage is that the secure hardware and software of the tachograph, and particularly the cryptographic functional unit thereof, which meets high security demands, can be used not only by the tachograph itself but also by the at least one functional unit of the vehicle. This means that said functional unit may be secure and reliable. In addition, it may be particularly inexpensive, since it does not require a dedicated cryptographic functional unit.

### BRIEF DESCRIPTION OF THE DRAWINGS

Exemplary embodiments of the invention are explained below with reference to the schematic drawings, in which:

FIG. 1 is a block diagram tachograph and functional units of a vehicle;

FIG. 2 is a first functional block diagram; and

FIG. 3 is a second functional block diagram.

Elements having the same design or function have been provided with the same reference symbols throughout the figures.

### DETAILED DESCRIPTION OF THE DRAWINGS

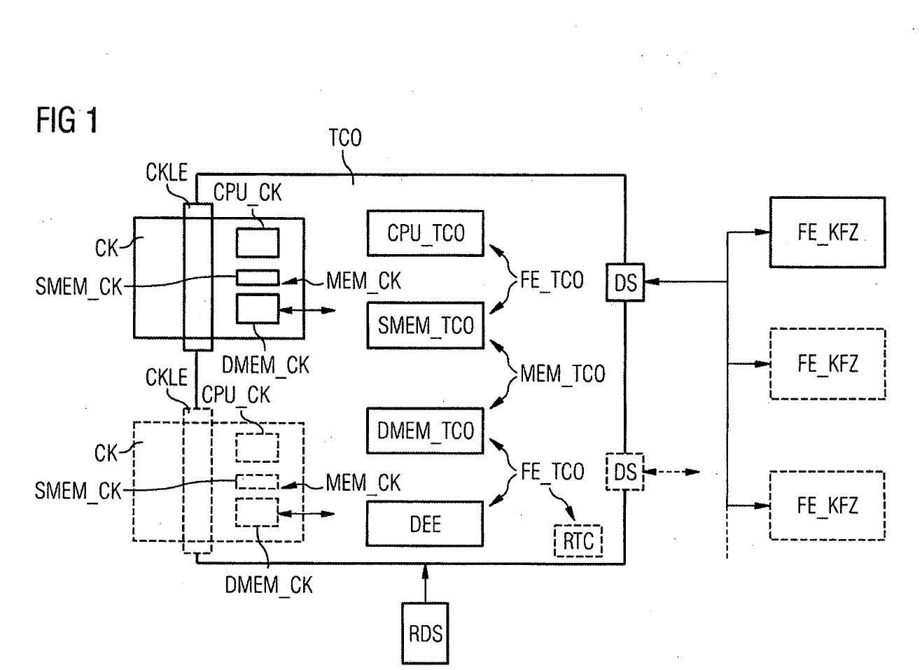

As shown in FIG. 1, tachograph TCO comprises at least one functional unit FE_TCO. The at least one functional unit FE_TCO of the tachograph TCO comprises particularly a computation unit CPU_TCO, a data capture unit DEE and at least one secure memory MEM_TCO. The at least one secure memory MEM_TCO comprises a secure key memory SMEM_TCO and/or a secure data memory DMEM_TCO. The secure key memory SMEM_TCO and the secure data memory DMEM_TCO may be designed separately from one another or else as a joint memory. The tachograph TCO may also comprise further functional units FE_TCO, for example a realtime clock RTC. The realtime clock RTC is preferably arranged in the tachograph TCO so as to be safe from manipulation and is designed to produce reliable and secure time stamps. The time stamps can particularly be used for data recording by the data capture unit DEE.

A vehicle in which the tachograph TCO is arranged preferably contains a wheel speed sensor RDS which can be coupled to the tachograph TCO. The wheel speed sensor RDS is required for prescribed operation of the tachograph TCO, that is to say particularly for securely storing travel data for later evaluation, particularly a speed of travel and a traveling time. By way of example, the data capture unit DEE is designed to capture the wheel speeds or speeds of travel captured by means of the wheel speed sensor RDS and to store them securely in the secure data memory DMEM_TCO of the tachograph TCO for later evaluation, preferably together with the time stamps provided by the realtime clock RTC.

The tachograph TCO comprises at least one chip card reading unit CKLE. The at least one chip card reading unit CKLE supplies the tachograph TCO with at least one chip card CK. The at least one chip card CK is also known as a tachograph card that is required for the prescribed operation of the tachograph TCO, or may be a workshop card, which is required for setup and maintenance work on the tachograph TCO in a workshop. By way of example, provision may be made for the realtime clock RTC to be able to be adjusted only when the workshop card is in the chip card reading unit CKLE. However, the at least one chip card CK may also be designed for a user-defined application. The user-defined application is preferably independent of the prescribed operation of the tachograph TCO. The at least one chip card reading unit CKLE preferably comprises a mechanical lock which secures the respective chip card in the respective chip card reading unit CKLE against removal. The lock makes it possible to prevent the at least one chip card CK from being removed without authorization.

The at least one chip card CK comprises a computation unit CPU CK and also at least one secure memory MEM_CK. The secure memory MEM_CK of the at least one chip card CK comprises a secure key memory SMEM_CK and/or a secure data memory DMEM_CK. The secure key memory SMEM_CK and the secure data memory DMEM_CK may be designed separately from one another or as a joint memory.

The secure key memory SMEM_TCO of the tachograph TCO and the secure key memory SMEM_CK of the at least one chip card CK respectively store at least one cryptographic key and possibly at least one certificate and possibly further cryptographic data. The data is stored particularly securely in the secure key memory SMEM_TCO of the tachograph TCO and in the secure key memory SMEM_CK of the at least one chip card CK protected against manipulation and/or against unauthorized access. The at least one cryptographic key which can be stored in the secure key memory SMEM_TCO of the tachograph TCO and in the secure key memory SMEM_CK of the at least one chip card CK is particularly a private key used for asymmetric encryption and/or for ascertaining a digital signature.

The secure data memory DMEM_TCO of the tachograph TCO and the secure data memory DMEM_CK of the at least one chip card CK are provided for securely storing data which, by way of example, has been digitally signed by the private key and the integrity of which can be checked by the digital signature and a public key. The data stored in the secure data memory DMEM_TCO of the tachograph TCO or in the secure data memory DMEM_CK of the at least one chip card CK are thereby protected against manipulation. The secure memory MEM_TCO of the tachograph TCO and/or the secure memory MEMO_CK of the at least one chip card CK may also be of different design, however. By way of example, the secure memory MEM_TCO of the tachograph TCO and/or the secure memory MEM_CK of the at least one chip card CK may alternatively or additionally be protected electrically and/or mechanically against unauthorized access or manipulation.

The secure memory MEM_CK of the at least one chip card CK of the tachograph card and of the workshop card securely stores a prescribed identification information item. This prescribed identification information item is output by an institute, particularly by a national institute and allows explicit and secure identification of the tachograph card or of the workshop card to the tachograph card TCO. The prescribed identification information item is prescribed particularly by law or decree and may be used exclusively for the purposes prescribed by law or decree.

Preferably in addition to the tachograph card and/or workshop card, at least one chip card CK is provided which, instead of the prescribed identification information item, comprises a user-defined identification information item IDI. The user-defined identification information item IDI can be defined by the manufacturer of the tachograph TCO or of the at least one chip card CK or by a user of the tachograph TCO or of the respective chip card CK. By way of example, the user is a company which uses the tachograph TCO in one of its vehicles. By way of example, the definition comprises the creation of a digital certificate and/or of a cryptographic key pair for asymmetric encryption. However, the user-defined identification information item may also be in a different form. In line with the prescribed identification information item, the user-defined identification information item IDI is also securely stored in the secure memory MEM_CK of the at least one chip card CK.

The user-defined identification information item IDI is preferably defined independently by the prescribed identification information item. This means that the at least one chip card CK, which comprises the user-defined identification information item IDI, can be used for applications for which the prescribed identification information item may not be used. This means that the company which uses the tachograph TCO in one of its vehicles, for example, is able to produce or have produced at least one digital certificate and/or at least one cryptographic key and/or at least one cryptographic key pair and/or at least one identifier, for example user identifier, as needed and in a manner suitable for its respective application in order to create self-defined identities in the form of the user-defined identification information item IDI and to use them for dedicated purposes independently of the prescribed operation of the tachograph TCO. In addition, the user-defined identification information item IDI may also comprise or encode further information, for example at least one access right and/or user right, possibly with a time limitation.

The tachograph TCO has a secure and preferably security certified piece of hardware which affords a secure environment for data processing and data storage. The secure memory MEM_TCO means that the tachograph TCO is also suitable for securely storing cryptographic keys and digital certificates and other data. To this end, the tachograph TCO is designed to execute secure and preferably security certified cryptographic algorithms, for example in order to allow the secure storage of data, for example by ascertaining and storing a digital signature from the data. To this end, the tachograph TCO comprises a cryptographic functional unit which, by way of example, is formed or comprised by the computation unit CPU_TCO of the tachograph TCO.

The tachograph TCO also comprises at least one data interface DS. The at least one data interface DS couples the tachograph TCO to at least one functional unit FE_KFZ in a vehicle in which the tachograph TCO is arranged. Such a functional unit FE_KFZ in the vehicle is an engine immobilizer, for example. The at least one functional unit FE_KFZ of the vehicle is not absolutely necessary for the prescribed operation of the tachograph TCO. The wheel speed sensor RDS and any other components or units of the vehicle which are required for the prescribed operation of the tachograph TCO are not a functional unit FE_KFZ in the vehicle in the sense of this document. The tachograph TCO is coupled by its at least one data interface DS, for example by a bus system, for example a CAN bus, to the at least one functional unit FE_KFZ of the vehicle. The coupling may also be in a different form, however.

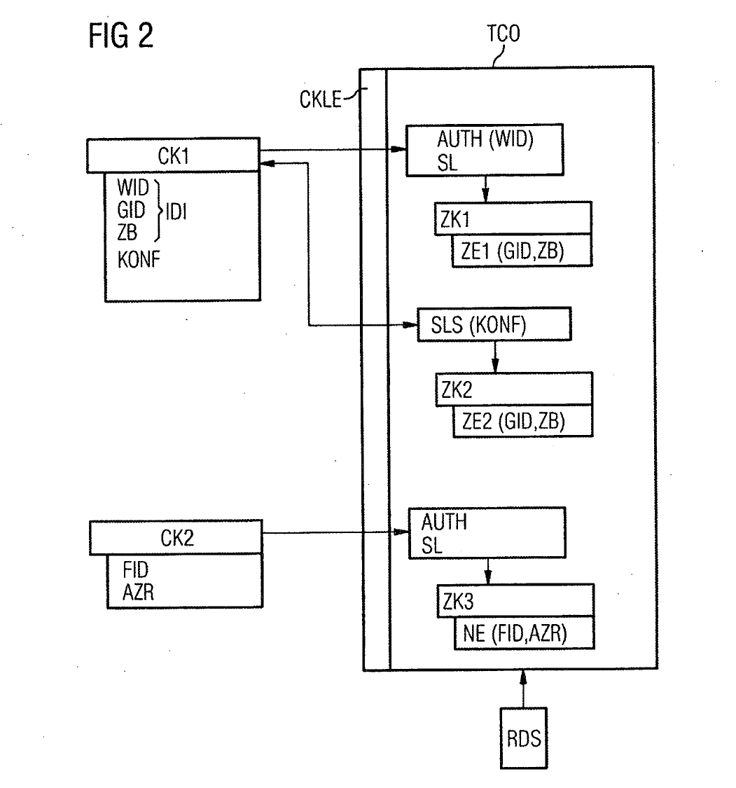

FIG. 2 shows a first functional diagram of the tachograph. By way of example, it shows a first chip card CK1, which comprises, as a user-defined identification information item IDI, a workshop identifier WID as user identifier, a user group identifier GD and an access area ZB. The workshop identifier WID is provided for identifying a workshop. The first chip card CK1 can therefore also be denoted as a user-defined workshop card. By way of example, the user-defined workshop card is accredited by the manufacturer of the tachograph. The advantage is that the workshop identifier WID and/or the user group identifier GID and/or the access area ZB can be used to individually equip workshops with respective user-defined access rights independently of legal provisions or decrees. In addition, the use of the user-defined workshop card is not tied to a few, prescribed workshops but rather can be allocated to any workshops, for example by the company which uses the tachograph TCO in one of its vehicles.

The first chip card CK1 can also store or be used to store configuration data KONF. The tachograph TCO is preferably configurable based on the configuration data KONF stored on the first chip card CK1. In addition, a current configuration of the tachograph TCO can be stored on the first chip card CK1 in the form of the configuration data KONF. This allows the configuration data KONF to be transmitted from the tachograph TCO to a further tachograph or to a plurality of further tachographs. What portions or areas of the configuration of the tachograph TCO can be stored on the first chip card CK1 in the form of the configuration data KONF and/or can be modified by the configuration data KONF stored on the first chip card CK1 is prescribable on the basis of the user-defined identification information item IDI.

When the first chip card CK1 is inserted into the chip card reading unit CKLE of the tachograph TCO, reciprocal authentication AUTH of the first chip card CK1 and of the tachograph TCO is performed. The authentication is effected based on the user-defined identification information item IDI. In particular, the workshop identifier WD is authenticated. The user-defined identification information item IDI is transmitted from the first chip card CK1 to the tachograph TCO by secure reading SL. The secure reading SL involves a digital signature for the digital data transmitted together with the transmitted data. Based on the digital signature and the transmitted data, the tachograph TCO can establish the integrity of the data and prevent manipulation of the data.

The authentication AUTH is followed by a first access control ZK1. The first access control ZK1 grants a first access permit ZE1 based on the user group identifier GID and the access area ZB. By way of example, the first access permit ZE1 relates to the portions or areas of the configuration of the tachograph TCO which can be modified by the configuration data KONF stored on the first chip card CK1 or which can be stored on the first chip card CK1 in the form of the configuration data KONF. The first access permit ZE1 relates particularly to a writing permission for writing to those portions or areas of the configuration which are not required for the prescribed operation of the tachograph, that is to say portions or areas of the configuration which are optional. In addition, the first access permit ZE1 can also relate to the at least one functional unit FE_TCO of the tachograph TCO and/or the at least one functional unit FE_KFZ of the vehicle.

The configuration data KONF can be read from the first chip card CK1 and transmitted to the tachograph TCO by secure reading and/or writing SLS or can be transmitted from the tachograph TCO to the first chip card CK1 and stored thereon. The secure reading and/or writing SLS is preferably likewise effected by providing and checking a digital signature or a message authentication code from the transmitted configuration data KONF. The message authentication code can also be referred to as MAC for short. This ensures the integrity of the transmitted configuration data KONF. When the configuration of the tachograph TCO is accessed, a second access control ZK2 is effected. Based on the user group identifier GID and the access area ZB, a second access permit ZE2 is granted for access to the portions or areas of the configuration which are allowed to be read and/or modified. In this way, the configuration data KONF can be securely transmitted from the tachograph TCO to at least one further tachograph, or the configuration data KONF can be transmitted from the at least one further tachograph to the tachograph TCO. This means that it is a very simple matter to transmit the configuration when the tachograph TCO is replaced in the vehicle. In addition, secure and simple configuration of customer-specific functions in the field is possible. By way of example, the tachograph TCO is configured automatically after the first chip card CK1 is inserted into the chip card reading unit CKLE on the basis of the configuration data KONF stored on said chip card. The tachograph TCO can thus be configured particularly easily and reliably.

In addition, a second chip card CK2 may be provided which can be supplied to the tachograph TCO via the at least one chip card reading unit CKLE. The second chip card CK2 represents an access control card for optional functions of the tachograph TCO and/or of the vehicle. The second chip card CK2 comprises a functional identifier FID and preferably an activation period AZR. The functional identifier FID identifies at least one of the functional units FE_TCO of the tachograph TCO and/or functional units FE_KFZ of the vehicle. The activation period AZR encodes the time limitation for the access right or for the use right for access to or use of the at least one functional unit FE_TCO of the tachograph TCO and/or functional unit FE_CFZ of the vehicle, said functional units being identified by the functional identifier FID. The activation period AZR prescribes an access period for access to the respective functional unit or a use period for use of the respective functional unit. The tachograph TCO is designed to permit or prevent use of the respective functional unit or access to the respective functional unit only within the period prescribed by the time limitation.

The tachograph TCO performs the authentication AUTH of the second chip card CK2. The functional identifier FID and the activation period AZR are transmitted from the second chip card CK2 to the tachograph TCO by means of the secure reading SL. The tachograph TCO performs a third access control ZK3. the third access control ZK3 grants or denies a use permit NE based on the functional identifier FID and the activation period AZR. The third access control ZK3 also checks whether the period prescribed by the activation period AZR for use of the at least one functional unit identified by the functional identifier FID is still running or has already elapsed. Accordingly, use of this at least one functional unit is permitted or prevented. By way of example, following payment of an appropriate fee, the second chip card CK2 can be used to enable at least one optional and/or customer-specific function of the tachograph TCO or of the vehicle for a prescribed period, for example one year.

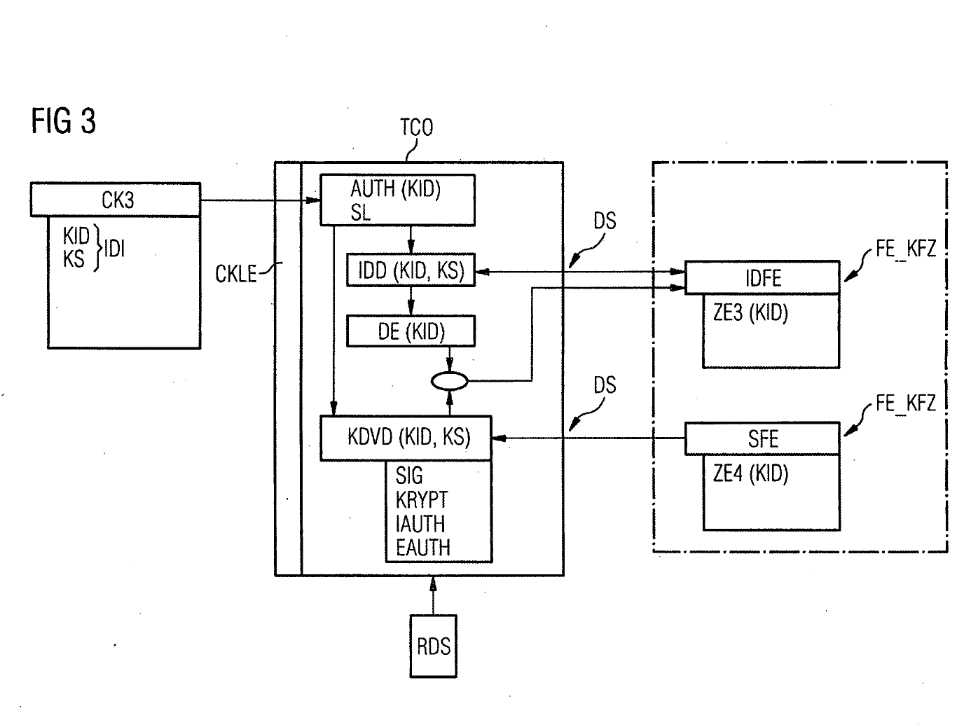

FIG. 3 is a second functional diagram of the tachograph. A third chip card CK3 identifies a driver of the vehicle, a company, a vehicle manufacturer or another identity. The third chip card CK3 represents an individual customer identification card or user identification card. The third chip card CK3 also comprises the user-defined identification information item IDI, which comprises a customer identifier KID as user identifier and at least one cryptographic customer key KS. By way of example, this user-defined identification information item IDI can be used to encrypt and/or decrypt and/or digitally sign data based on the at least on customer key KS. Such a user-defined identification information item IDI may also be stored in the secure memory MEM_TCO of the tachograph TCO, so that use of the user-defined identification information item IDI does not require the third chip card CK3 to be inserted into the chip card reading unit CKLE. However, the third chip card CK3 can be used, for example when setting up the tachograph TCO, to transmit the user-defined identification information item IDI to the tachograph TCO and to store it therein.

The tachograph TCO performs the authentication AUTH of the third chip card CK3. This authenticates the customer identifier KID. By way of example, the at least one customer key KS comprises a private key and a public key for asymmetric encryption. The at least one customer key KS may also be in a different form. The secure reading SL transmits the at least one customer key KS and particularly the public key to the tachograph TCO.

The tachograph TCO is preferably designed to provide an identification service IDD. The at least one data interface DS can be used by the identification service IDD to provide the customer identifier KID and/or the at least one customer key KS or components thereof for the at least one functional unit FE_KFZ of the vehicle, and hence the user can take the customer identifier KID and the at least one customer key KS as a basis for identifying himself to the at least one functional unit FE_KFZ of the vehicle. In addition, provision may be made for data capture DE to be performed for the customer identifier KID. The data capture DE preferably involves time stamps from the realtime clock RTC also being captured and recorded. This means that it is possible to establish, during a subsequent evaluation, when the customer identifier KID was used or when the third chip card CK3 was inserted in the chip card reading unit CKLE. In addition, the customer identifier KID can also be provided in secure form, that is to say together with an associated digital signature, for example, by means of the at least one data interface DS. On the basis of the digital signature and the public key of the at least one customer key KS, the respective functional unit FE_KFZ of the vehicle can check the integrity of the customer identifier KID. The customer identifier KID and/or the customer key KS and particularly the public key can be sent to all functional units FE_KFZ of the vehicle via the least one data interface DS or can be sent to one of the functional units FE_KFZ of the vehicle upon request by said functional unit.

The at least one functional unit FE_KFZ of the vehicle, which uses the customer identifier KID, is particularly an identification-dependent functional unit IDFE which allows access to it or use of it only when a prescribed customer identifier KID is present. By way of example, the identification-dependent functional unit IDFE may be used only by a prescribed company or a prescribed user, for example a prescribed driver. An example of such a functional unit FE_KFZ of the vehicle is the engine immobilizer. Based on the customer identifier KID, a third access permit ZE3 is granted or denied, that is to say the engine immobilizer is deactivated or activated, for example.

In addition, the tachograph TCO can also provide a cryptographic data processing service KDVD for cryptographically processing data for the at least one functional unit FE_KFZ of the vehicle and particularly for a security-assisted and/or security-providing functional unit SFE. By way of example, the cryptographic data processing service KDVD is designed to encrypt or decrypt data and/or digitally sign data or check signed data and/or produce or check the message authentication code upon request by the at least one functional unit FE_KFZ of the vehicle and particularly the security-assisted and/or security-providing functional unit SFE. For these purposes, a signature service SIG for producing and checking digital signatures, an encryption and decryption service KRYPT for encrypting and decrypting data, an internal authentication service IAUTH and an external authentication service EAUTH are provided for the purpose of authentication of the tachograph TCO and of the respective functional unit FE_KFZ of the vehicle or for the purpose of authenticating a vehicle-external system, for example a personal computer in the company, which is coupled to the vehicle by a radio link thereto for the purpose of data interchange.

The security-assisted and/or security-providing functional unit grants or denies a fourth access permit ZE4 on the basis of the customer identifier KID. By way of example, this forms an electronic seal which permits access to or use of the security-assisted and/or security-providing functional unit SFE only for that user who has already previously used the security-assisted and/or security-providing functional unit SEE at least once. In addition, the security-assisted and/or security-providing functional unit SFE may be designed to use the radio link or else to use a cable link to interchange data with a vehicle-external unit, for example with the personal computer. Thus, it may be necessary or advantageous to encrypt or decrypt or sign the data. In addition, provision may be made for data to be securely stored. For the purpose of secure storage of the data, said data can be transmitted to the tachograph TCO. The data can be stored in the tachograph

TCO, particularly in the secure data memory DMEM_TCO, or transmitted back to the security-assisted and/or security-providing functional unit SFE, having been signed by the signature service SIG and/or encrypted by the encryption and decryption service KRYPT, so as subsequently to be stored in said functional unit SFE.

The authentication AUTH, the first, second, and third access control ZK1, ZK2, ZK3, the identification service IDD, and the cryptographic data processing service KDVD and also the secure reading SL in the secure reading and/or writing SLS are formed by the at least one functional unit FE_TCO of the tachograph TCO or are implemented by said functional unit, particularly by the cryptographic functional unit, which is formed by the computation unit CPU_TCO of the tachograph TCO, for example, which computation unit interacts with the secure memory MEM_TCO.

Preferably, the digital signature comprises a time stamp, which can be produced by the realtime clock RTC, for example, and/or a sequence number. This allows particularly good protection against manipulation.

By using the user-defined identification information item with the tachograph TCO, that is to say by using the secure hardware and software of the tachograph TCO, it is possible to achieve the same high level of security and reliability for user-defined applications as for the prescribed operation of the tachograph TCO. The advantage is that this does not require the provision of an additional unit in the vehicle and/or in the at least one functional unit FE_KFZ of the vehicle. Use of the tachograph TCO with the user-defined identification information item IDI for user-defined applications is therefore particularly inexpensive.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-7. (canceled)

8. A tachograph comprising:
at least one chip card, the at least one chipcard comprising:
a secure memory configured to store at least one user-defined identification information item independent of an identification information item for prescribed operation of the tachograph; and
a secure data transmission unit configured to transmit the at least one user-defined identification information item independent of an identification information item prescribed for operation of the tachograph; and
at least one chip card reading unit configured to accept the at least one chip card, wherein the tachograph is configured to:
authenticate the at least one chip card based at least in part on the at least one user-defined identification information item, and to at least one of read data in secure form from the at least one chip card, and store data in secure form on the at least one chip card.

9. The tachograph according to claim 8, wherein
the at least one user-defined identification information item encodes at least one of:
at least one access right for access to at least one functional unit and
at least one use right for use of the at least one functional unit,
wherein the tachograph is configured to use the at least one user-defined identification information item as a basis for permitting or preventing at least one of access to at least one functional unit and use of the at least one functional unit.

10. The tachograph according to claim 9, wherein the access right or the use right comprises a time limitation, and
the tachograph is configured to use the time limitation as a basis for one of
limiting at least one of an access period for access to the at least one functional unit, or a use period for use of the at least one functional unit, and
permitting or preventing the access to the at least one functional unit, and the use of the at least one functional unit only within a period prescribed by the time limitation.

11. The tachograph according to claim 8, further comprising:
at least one data interface configured to send and receive data to and from at least one functional unit in a vehicle,
wherein the data interface is configured to provide at least one of the at least one user-defined identification information item and a component of the at least one user-defined identification information to the at least one functional unit of the vehicle via the at least one data interface.

12. The tachograph according to claim 11, wherein the tachograph is configured to provide the at least one user-defined identification information item or the component of the at least one user-defined identification information for the at least one functional unit of the vehicle such that it can be verified cryptographically.

13. The tachograph according to claim 8, further comprising:
at least one data interface configured for sending and receiving data to and from at least one functional unit in a vehicle; and
at least one cryptographic functional unit provided for a prescribed operation of the tachograph, the at least one cryptographic functional unit configured to at least one of cryptographically process data, securely store data, and securely provide data,
wherein the data is supplied to the tachograph by the at least one functional unit of the vehicle via the at least one data interface based at least in part on the at least one user-defined identification information item.

14. A tachograph comprising:
at least one data interface configured to send and receive data to and from at least one functional unit in a vehicle; and
at least one cryptographic functional unit provided for a prescribed operation of the tachograph, and
wherein the at least one cryptographic functional unit is configured to at least one of:
cryptographically process,
securely store, and
securely provide,
data supplied to the tachograph by the at least one functional unit of the vehicle via the at least one data interface for the at least one functional unit of the vehicle.
